(19) United States
(12) Patent Application Publication
(10) Pub. No.: US 2026/0180361 A1
(43) Pub. Date: Jun. 25, 2026

(54) AC POWERED REMOTE DEVICES

(71) Applicant: Pass & Seymour, Inc., Syracuse, NY (US)

(72) Inventors: Joshua Ryan, Syracuse, NY (US); Frederick Duffy, Middletown, PA (US)

(73) Assignee: Pass & Seymour, Inc., Syracuse, NY (US)

(21) Appl. No.: 19/429,583

(22) Filed: Dec. 22, 2025

Related U.S. Application Data
(60) Provisional application No. 63/737,953, filed on Dec. 23, 2024.

(51) Int. Cl. H02J 13/34; H01H 13/10; H01H 13/14; H01H 15/00; H01H 21/12; H01H 21/22; H02J 13/13; H02M 7/00; H02M 7/06

(52) U.S. Cl. CPC H02J 13/34; H01H 13/10; H01H 13/14; H01H 15/005; H01H 21/12; H01H 21/22; H02J 13/1335; H02M 7/003; H02M 7/068

(57) ABSTRACT

The described technology pertains to an electrical wiring device, such as a smart switch or dimmer, powered by AC mains for wireless control of electrical loads. The device includes a power supply circuit on a first PCB that converts AC to DC, and an RF switch circuit on a second PCB enabling wireless communication. An actuator facilitates the initiation of wireless commands. A divider physically separates live-voltage components to improve user safety. The device removes the need for battery maintenance, supports uninterrupted operation, and is applicable in residential, commercial, and hospitality settings.

### CROSS-REFERENCE TO RELATED APPLICATIONS

The present application relates and claims priority to Applicant's U.S. Provisional Patent Application Ser. No. 63/737,953, filed Dec. 23, 2024, the entirety of which is hereby incorporated by reference.

### FIELD OF INVENTION

The present disclosure pertains to electrical wiring devices, and specifically to smart switches and dimmers powered by AC mains for wireless management of electrical loads.

### BACKGROUND

As those of ordinary skill in the art understand, smart switches, dimmers, and sensors are increasingly used in residential and commercial environments to enable wireless control of lighting and other electrical loads. These devices often utilize wireless communication protocols, including ZigBee, Bluetooth, and Wi-Fi, to interact with central controllers, hubs, or smart devices directly. A common approach for powering such devices is the use of batteries, which allows for flexible installation without the need for direct connection to AC mains power.

However, reliance on battery power introduces several challenges. Battery-powered smart switches require periodic maintenance to replace or recharge batteries, which can be particularly burdensome in settings with many such devices, such as hotels, offices, or hospitals. The need for frequent battery changes increases operational costs and can lead to device downtime if batteries are depleted before maintenance occurs. Additionally, to conserve battery life, these devices often enter low-power sleep modes when not in active use. While this extends battery longevity, this practice can result in delayed response times, missed communications, or temporary loss of connectivity with the wireless network, especially if the device does not activate frequently enough to maintain pairing or receive updates.

Accordingly, there is a need for improved solutions that address the maintenance, reliability, and performance limitations associated with battery-powered smart electrical wiring devices, while maintaining compatibility with existing installation standards and wireless communication protocols. Further, there is a need to ensure the safety of users of the smart device, as hard wiring a smart device to AC mains can expose users to dangerous voltages if the front cover is removed.

### SUMMARY

According to an aspect, an electrical wiring device for installation within an electrical wall box, the device includes: a power supply circuit disposed on a first printed circuit board, the power supply circuit being connected to AC mains and outputting a DC power signal, wherein the first printed circuit board is positioned within a backbody of the electrical wiring device; an RF switch circuit for providing wireless commands to a smart device disposed on a second printed circuit board, the RF switch circuit being powered by the DC power signal; an actuator in mechanical communication with the RF switch circuit to initiate wireless control of a remote electrical load; and a divider interposed between the first printed circuit board and the second printed circuit board, the divider being configured to physically isolate live-voltage components of the first printed circuit board and to prevent user contact therewith upon removal of a front cover of the electrical wiring device.

In one example, the divider is ground strap. In another example, the divider is a separator.

In an example, the electrical wiring device further includes a pair of wires extending through the divider to carry the DC power signal from the power supply circuit to the RF switch circuit. In another example, the pair of wires extends around the divider to carry the DC power signal from the power supply circuit to the RF switch circuit.

In an example, the power supply circuit is an isolated power supply circuit.

In an example, the isolated power supply circuit comprises a flyback converter having a transformer for isolating the DC power signal.

In an example, the RF switch circuit is further configured to step down the voltage of the DC power signal.

In an example, the RF switch circuit does not employ a sleep mode requiring a “wake up” for update.

In an example, the RF switch circuit is configured to communicate with at least one connected device to prevent the at least one connected device from unpairing with the RF switch circuit.

In an example, the RF switch circuit is configured to communicate via at least one wireless protocol selected from the group consisting of ZigBee, Bluetooth, and Wi-Fi.

In an example, the actuator includes a rocker paddle mounted in a trim ring in a manner that allows rotational movement. In an example, the actuator further includes a dimmer slider coupled to the rocker paddle for adjusting a brightness level of the remote electrical load.

In an example, the actuator includes at least one push-button configured to transmit predefined lighting control commands to the smart device. In an example, the actuator includes a motion sensor configured to detect occupancy and generate a control input signal for the RF switch circuit.

In an example, the actuator is connected to a trim ring, wherein the trim includes a tab that is positioned and dimensioned to fit beneath a wall plate when installed, the tab preventing the trim ring from being pulled away from the electrical wiring device. In another example, the trim ring is fastened to the divider with a screw, preventing the trim ring from being pulled away from the electrical wiring device.

### DESCRIPTION OF THE FIGURES

FIG. 1A is an exploded perspective view of an example electrical wiring device.

FIG. 1B is an exploded perspective view of an example electrical wiring device.

FIG. 2A is an exploded perspective view of an example electrical wiring device.

FIG. 2B is an exploded perspective view of an example electrical wiring device.

FIG. 3 is a schematic of an isolated power supply, according to an example.

### DETAILED DESCRIPTION

The present disclosure addresses the limitations of a battery powered RF switch by providing a switch that is powered directly by AC mains while incorporating safety and performance features. The device includes a power supply circuit on a first printed circuit board (PCB) that converts AC power to a suitable DC voltage, and an RF switch circuit on a second PCB that facilitates wireless communication using protocols such as ZigBee, Bluetooth, or Wi-Fi. The power supply can be isolated to provide further user safety. A physical divider, such as a ground strap or separator, is interposed between the two PCBs to isolate live-voltage components, ensuring user safety by preventing contact with high-voltage elements upon removal of the device's front cover. This architecture eliminates the need for battery maintenance, enabling continuous operation without the interruptions associated with battery depletion or sleep modes. Furthermore, the device maintains uninterrupted communication with connected systems, preventing unpairing or connectivity loss. By addressing both the performance and safety challenges of prior solutions, the disclosure provides a robust, reliable, and user-friendly alternative for wireless control of electrical loads.

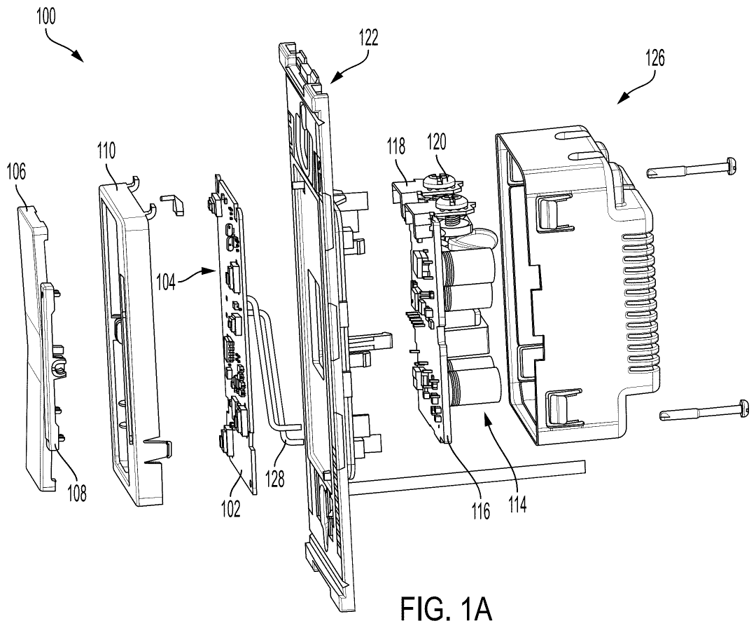

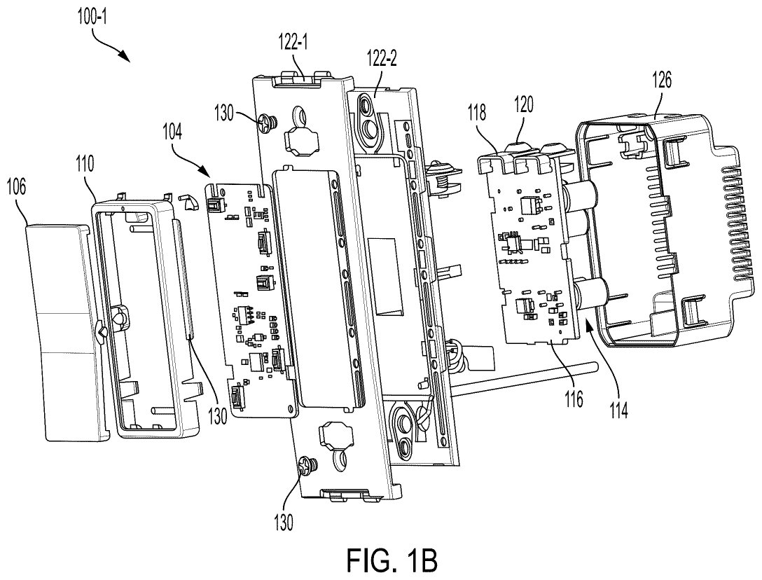

FIGS. 1A-1B depicts an example of an electrical wiring device 100 with RF control capability. As shown, the electrical wiring device 100 includes RF control PCB 102, on which is disposed an RF switch circuit 104 for providing wireless commands to a smart device. The wireless command signal be sent through any wireless protocol/technology, including, but not limited to, ZigBee standards-based protocol, Bluetooth technology, and/or Wi-Fi technology. The pairing of electrical wiring device 100 with the remote device can be accomplished via known methods. It should be understood that communicating with the remote device can occur through direct communication or through one or more intermediate devices, such as through a mesh network or a hub, and including through the cloud. Electrical switches and dimmer circuits, transceivers, and the remote operation of switches through protocols such as ZigBee, Bluetooth, Wi-Fi, etc., is known in the art, and any suitable smart switch circuit can be used.

The electrical wiring device can further include an actuator for operating the RF switch circuit. As shown in FIG. 1A, the actuator is implemented as a paddle 106 and dimmer paddle 108, i.e., a paddle with a slider to implement a dimming feature. However, it should be understood that any suitable actuator can be used. For example, alternatively, the actuator can include buttons for implementing home/away features or to implement various preset lighting features. In other examples, the actuator can be a motion detector or a wave or touch switch. Other actuators are, for example, shown in US 2022/0246372, titled “Battery powered devices,” which is incorporated by reference in its entirety.

Paddle 106, in the example shown, is disposed in a trim ring 110 for supporting paddle 106 and for covering (e.g., enclosing) RF control PCB 102. Here, trim ring 110 includes features for permitting paddle 106 to rock back and forth in response to a user pressing the paddle 106.

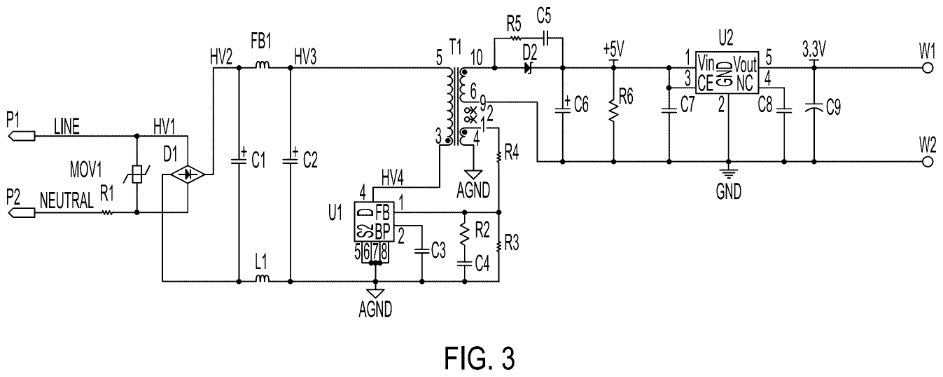

The RF switch circuit 104 is powered by the power supply circuit 114 disposed on the PCB denoted AC PCB 116. The power supply circuit 114, for safety reasons, is an isolated power supply. Any suitable power supply circuit topology for converting AC power from AC mains (e.g., 120 V, 60 Hz) to a voltage suitable for powering the RF switch circuit can be used. An example of a suitable power supply is described in connection with FIG. 3. AC mains is provided to power supply circuit 114 via terminals 118. Terminals 118 can include terminal screws 120 for connecting line and hot wires from the wall box.

As shown in the example of FIG. 1, AC PCB 116 is separated from RF control PCB 102 by a ground strap 122, which is dimensioned and designed to be mounted into a wall box. Ground strap 122 can also provide a degree of protection for a user, preventing a user, installing the electrical wiring device, from coming into contact with the higher voltage of AC mains, input to the AC PCB 116.

A pair of wires 128 can extend through or around the ground strap 122 to connect the AC PCB 116 to the RF control PCB 102. Additionally, the AC PCB 116 can be disposed within a backbody 126, together with the trim ring 110 and ground strap 122, to provide a complete enclosure of the device 100.

An alternative example of FIG. 1A is shown in FIG. 1B. This example is the same as FIG. 1A, except for tab feature 130, which is positioned and sized to fit under the wall plate, preventing a user from pulling trim ring away from the wall plate and potentially exposing the internals, including higher-voltage components.

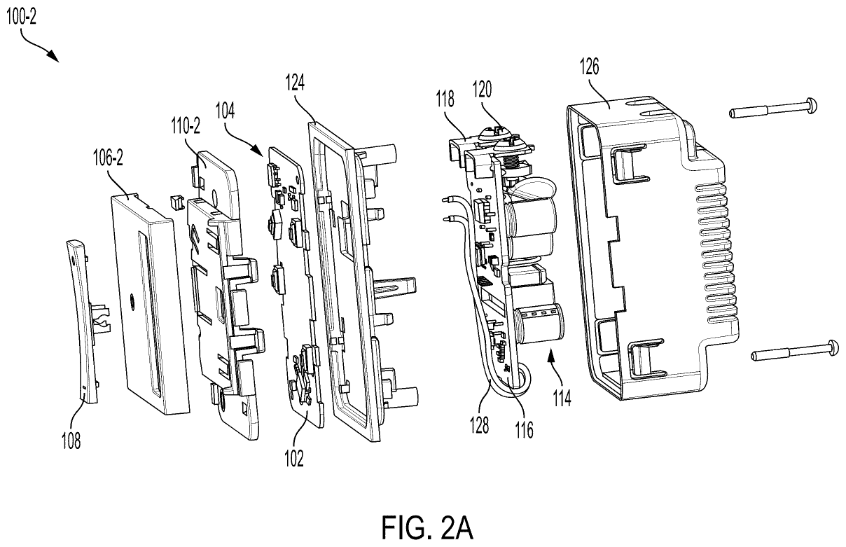

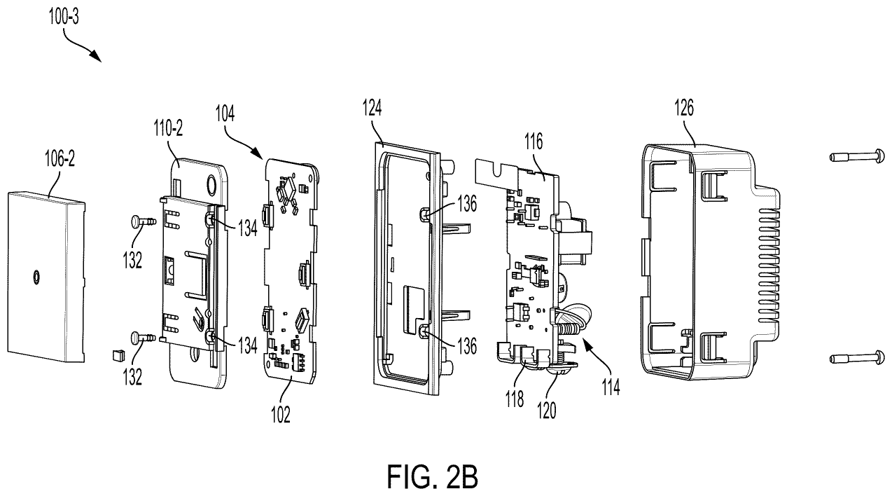

FIG. 2A provides an alternative example, electrical wiring device 100-2, which includes a separator 126, rather than a ground strap, for separating the RF control PCB 102 from the AC PCB 116. The example of FIG. 2A likewise includes a different actuator example, a single tap press paddle 106-2, with dimmer paddle 108, necessitating a trim 110-2, with front features to receive paddle 106-2. The back features of ground strap 122 and separator 126 can be configured to either accept a battery in an alternative example to AC PCB 116, thus providing manufacturing flexibility and the ability to reuse components between battery-powered and power-supply-powered version of the device. Common features between FIG. 1 and FIG. 2 are assigned the same reference numeral.

FIG. 2B depicts an alternative example, electrical wiring device 100-3. This example is the same as FIG. 2A, except for the inclusion of screws, which are inserted into holes 134 in trim ring 110-2 and engage with threaded bores 136 in separator 124. (In an alternative example, trim ring can likewise include threaded bores.) Screws 132, once inserted, prevent simple removal of trim ring 110-2, thereby protecting the internals of electrical wiring device 100-3, and users from the risk of shock. (FIG. 2B is inverted with respect to 2A to better reveal the holes 134 and 136.)

An example suitable power supply circuit 300, as can be implemented on AC PCB 116, is shown in FIG. 3. As shown, FIG. 3 is a flyback converter that comprises a transformer T1 and diode d2, and which is controlled by flyback controller U1 via pin 4. Other aspects of power supply 300 will be understood by a person of ordinary and described only briefly. On the primary side, a full bridge rectifier D1 converts the input AC mains signal to a high voltage DC signal. The converted DC signal is input to a low pass Pi filter comprising inductor FB1 and capacitors C1 and C2, for removing high frequency EMI components. The flyback converter down converts the voltage, according to the turns of primary and secondary winding of T1 and the drive signal provided by U1. On the secondary side, snubber circuit comprising resistor R5 and capacitor C5, suppresses ringing. Output smoothing capacitors C6 and C7 smooth the output voltage to remove ripples from the output of diode D2. The output of this is +5 V, which can be input to linear regulator U2 and output smoothing capacitor C9 for a +3.3 V DC signal supplied to output terminals W1 and W2.

Because transformer T1 transfers power wirelessly (from the primary winding to the secondary winding of T1), power supply 300 is an isolated power supply. The use of an isolated power supply means that a user, opening the front cover, will not contact any terminal or part of a circuit which has a connection to line hot, thus reducing the risk of electric shock.

It should be understood that some amount of converting the input voltage to a suitable value can be performed on a circuit disposed on RF control PCB, thus distributing the functions of providing power to the RF switch circuit. For example, linear regulator U2 and smoothing capacitor C9 can be disposed on the RF control PCB 102 to perform the final step of converting the voltage to the value used by the RF control PCB 102.

A wired smart dimmer provides several advantages over a similar battery powered device. For starters, using wired power avoids the need for changing batteries. Because these switches are frequently used in hospitality settings, such as hotels, maintaining batteries can be difficult to manage. Further, to conserve power, battery powered devices frequently go to sleep when not used for an extended period. This requires periodically “waking up” to determine if a system update is required. This is not required in a wired device as shown in FIGS. 1 and 2 and described herein. Additionally, including a wired device can improve conductivity. A wireless system can unpair from a device, if it does not “hear” from the paired device for a period of time. By continuously providing power to the RF switch circuit, the electrical wiring device can communicate with the wireless system to remain paired.

It should be understood that the values used above are only representative values, and other values may be in keeping with the spirit and intention of this disclosure.

While several inventive embodiments have been described and illustrated herein with reference to certain exemplary embodiments, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein (and it will be understood by one skilled in the art that various changes in detail may be effected therein without departing from the spirit and scope of the invention as defined by claims that can be supported by the written description and drawings). More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto; inventive embodiments may be practiced otherwise than as specifically described and claimed. Further, where exemplary embodiments are described with reference to a certain number of elements it will be understood that the exemplary embodiments can be practiced utilizing either less than or more than the certain number of elements.

All references, including publications, patent applications, and patents, cited herein are hereby incorporated by reference to the same extent as if each reference were individually and specifically indicated to be incorporated by reference and were set forth in its entirety herein.

All definitions, as defined and used herein, should be understood to control over dictionary definitions, definitions in documents incorporated by reference, and/or ordinary meanings of the defined terms.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

The recitation of ranges of values herein are merely intended to serve as a shorthand method of referring individually to each separate value falling within the range, unless otherwise indicated herein, and each separate value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not impose a limitation on the scope of the invention unless otherwise claimed.

No language in the specification should be construed as indicating any non-claimed element as essential to the practice of the invention.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

It will be apparent to those skilled in the art that various modifications and variations can be made to the present invention without departing from the spirit and scope of the invention. There is no intention to limit the invention to the specific form or forms disclosed, but on the contrary, the intention is to cover all modifications, alternative constructions, and equivalents falling within the spirit and scope of the invention, as defined in the appended claims. Thus, it is intended that the present invention cover the modifications and variations of this invention provided they come within the scope of the appended claims and their equivalents.

What is claimed is:

1. An electrical wiring device for installation within a electrical wall box, the device comprising:
a power supply circuit disposed on a first printed circuit board, the power supply circuit being connected to AC mains and outputting a DC power signal, wherein the first printed circuit board is positioned within a backbody of the electrical wiring device;
an RF switch circuit for providing wireless commands to a smart device disposed on a second printed circuit board, the RF switch circuit being powered by the DC power signal;
an actuator in mechanical communication with the RF switch circuit to initiate wireless control of a remote electrical load; and
a divider interposed between the first printed circuit board and the second printed circuit board, the divider being configured to physically isolate live-voltage components of the first printed circuit board and to prevent user contact therewith upon removal of a front cover of the electrical wiring device.

2. The device of claim 1, wherein the divider is ground strap.

3. The device of claim 1, wherein the divider is a separator.

4. The device of claim 1, further comprising a pair of wires extending through the divider to carry the DC power signal from the power supply circuit to the RF switch circuit.

5. The device of claim 1, further comprising a pair of wires extending around the divider to carry the DC power signal from the power supply circuit to the RF switch circuit.

6. The device of claim 1, wherein the power supply circuit is an isolated power supply circuit.

7. The device of claim 6, wherein the isolated power supply circuit comprises a flyback converter having a transformer for isolating the DC power signal.

8. The device of claim 1, wherein the RF switch circuit is further configured to step down the voltage of the DC power signal.

9. The device of claim 1, wherein the RF switch circuit does not employ a sleep mode requiring a “wake up” for update.

10. The device of claim 1, wherein the RF switch circuit is configured to communicate with at least one connected device to prevent the at least one connected device from unpairing with the RF switch circuit.

11. The device of claim 1, wherein the RF switch circuit is configured to communicate via at least one wireless protocol selected from the group consisting of ZigBee, Bluetooth, and Wi-Fi.

12. The device of claim 1, wherein the actuator includes a rocker paddle mounted in a trim ring in a manner that allows rotational movement.

13. The device of claim 12, wherein the actuator further includes a dimmer slider coupled to the rocker paddle for adjusting a brightness level of the remote electrical load.

14. The device of claim 1, wherein the actuator includes at least one push-button configured to transmit predefined lighting control commands to the smart device.

15. The device of claim 1, wherein the actuator includes a motion sensor configured to detect occupancy and generate a control input signal for the RF switch circuit.

16. The device of claim 1, wherein the actuator is connected to a trim ring, wherein the trim includes a tab that is positioned and dimensioned to fit beneath a wall plate when installed, the tab preventing the trim ring from being pulled away from the electrical wiring device.

17. The device of claim 1, wherein the actuator is connected to a trim ring, wherein the trim ring is fastened to the divider with a screw, preventing the trim ring from being pulled away from the electrical wiring device.
